(19) United States
(12) Patent Application Publication
(10) Pub. No.: US 2010/0018004 A1
(43) Pub. Date: Jan. 28, 2010

(54) VEHICULAR CHECKER-EQUIPPED DOOR HINGE DEVICE

(76) Inventors: Manabu Ochiai, Saitama (JP); Kazuaki Kurosawa, Saitama (JP)

Correspondence Address: CARRIER BLACKMAN AND ASSOCIATES, 43440 WEST TEN MILE ROAD, EATON CENTER, NOVI, MI, 48375, US

(21) Appl. No.: 12/312,327

(22) PCT Filed: Nov. 28, 2007
(86) PCT No.: PCT/JP2007/072946

§ 371 Date: May 5, 2009

(30) Foreign Application Priority Data
Dec. 1, 2006 (JP) 2006-326113
Jul. 20, 2007 (JP) 2007-190018

(51) Int. Cl. E05D 11/10; E05D 11/00

(52) U.S. Cl. 16/250; 16/319

(57) ABSTRACT

A vehicular checker-equipped door hinge device is provided that includes an inner tube (6) joined to a female bracket (1), an outer tube (7) joined to a male bracket (2), and a check force generation mechanism (20) provided between the two tubes (6, 7), the mechanism (20) including a plurality of retaining members (22) that are mounted on the outer tube (7) so as to be arranged in the peripheral direction and that are capable of moving toward and away from the inner tube (6), and a plurality of resilient members (23) individually urging these retaining members (22) toward the inner tube (6); each of the retaining members (22) is provided with a detent projection (26) projecting so as to abut against an outer peripheral face of the inner tube (6), a plurality of detent grooves (27) that the detent projection (26) engages with and disengages from in response to relative rotation of the inner tube (6) and the outer tube (7) are provided on the outer peripheral face of the inner tube (6), and a pressure-receiving area of the retaining member (22) that receives pressure from the resilient member (23) is set so as to be larger than an abutment area of the detent projection (26) against the detent groove (27). This enables a vehicular checker-equipped door hinge device to be provided that does not lose the check function even if part of the check force generation mechanism malfunctions and, moreover, that has high durability.

### TECHNICAL FIELD

The present invention relates to a vehicular door hinge device for supporting a door that opens and closes an entrance or a tailgate of an automobile, etc. and, in particular, to an improvement of a vehicular checker-equipped door hinge device that includes a first bracket secured to one of a body and a door, a second bracket secured to the other thereof, a hinge pin relatively pivotably connecting these two brackets, an inner tube integrally joined to the first bracket and disposed coaxially with the hinge pin, an outer tube integrally joined to the second bracket and disposed so as to relatively rotatably surround the inner tube, and a check force generation mechanism provided between the inner tube and the outer tube and generating a check force for the door at a predetermined degree of opening position of the door.

### BACKGROUND ART

Such a vehicular checker-equipped door hinge device is already known, as disclosed in Patent Publication 1 below.
[Patent Publication 1] U.S. Pat. No. 6,481,056

### DISCLOSURE OF INVENTION

### Problems to be Solved by the Invention

In such a vehicular checker-equipped door hinge device, the check force generation mechanism is formed from a retainer mounted on the outer tube and rotating therewith, detent rollers supported on the retainer and rolling on an outer peripheral face of the inner tube, a coil spring wrapped around a group of the detent rollers and exhibiting a resilient recoil in the radial direction so as to urge each detent roller toward the outer peripheral face side of the inner tube, and a plurality of detent grooves provided on the outer peripheral face of the inner tube so as to extend in the axial direction and be positioned at intervals in the peripheral direction, the detent roller engaging with and disengaging from the detent grooves in response to relative rotation of the inner tube and the outer tube. In such a conventional arrangement, since a single coil spring acts in common on a plurality of detent rollers, if the coil spring is broken, all of the detent rollers lose the check function. Furthermore, since the detent rollers and the coil spring are always in high surface pressure line contact with each other, the detent rollers and the coil spring are easily worn.

The present invention has been accomplished in the light of such circumstances, and it is an object thereof to provide a vehicular checker-equipped door hinge device in which even if part of a check force generation mechanism malfunctions, the check function is not lost, and which has high durability.

### Means of Solving the Problems

In order to attain the above object, according to a first aspect of the present invention, there is provided a vehicular checker-equipped door hinge device comprising a first bracket secured to one of a body and a door, a second bracket secured to the other one thereof, a hinge pin relatively pivotably connecting these two brackets, an inner tube integrally joined to the first bracket and disposed coaxially with the hinge pin, an outer tube integrally joined to the second bracket and disposed so as to relatively rotatably surround the inner tube, and a check force generation mechanism provided between the inner tube and the outer tube and generating a check force on the door at a predetermined degree of opening position of the door, characterized in that the check force generation mechanism comprises a plurality of retaining members that are mounted on one of the inner tube and the outer tube so as to be arranged in the peripheral direction and that are capable of moving toward and away from the other one of the inner tube and the outer tube, and a plurality of resilient members individually urging these retaining members toward the other one, each of the retaining members is provided with a detent projection projecting so as to abut against a peripheral face of the other one, a plurality of detent grooves that the detent projection engages with and disengages from in response to relative rotation of the inner tube and the outer tube are provided on a peripheral face of the other one, and a pressure-receiving area of the retaining member that receives pressure from the resilient member is set so as to be larger than an abutment area of the detent projection against the detent groove.

The first and second brackets correspond to a female bracket 1 and a male bracket 2 in an embodiment of the present invention, which is described later, and the detent projection corresponds to a detent roller 26.

According to a second aspect of the present invention, in addition to the first aspect, the first bracket is provided with a pair of female arm portions that support opposite end parts of the hinge pin and are joined to the inner tube, the inner tube being disposed on the outer periphery of the hinge pin, the second bracket is provided with a pair of male arm portions that are disposed so as to be adjacent to the inside of the female arm portion and are relatively rotatably supported on the outer periphery of opposite end parts of the inner tube via bearing bushes, and the outer tube is joined to the two male arm portions, the outer tube being disposed therebetween.

According to a third aspect of the present invention, in addition the first or second aspect, a mounting recess opening toward an outer peripheral face of the inner tube is provided on an inner peripheral face of the outer tube, the retaining member comprises a pair of end wall portions supported on the mounting recess and a flexible connecting wall portion integrally connecting the end wall portions so as to close the mounting recess, the detent projection being provided on the connecting wall portion, the resilient member urging the connecting wall portion toward the inner tube side is housed in the mounting recess, and the plurality of detent grooves are provided on an outer peripheral face of the inner tube.

According to a fourth aspect of the present invention, in addition to the first or second aspect, a mounting recess opening toward an inner peripheral face of the outer tube is provided on an outer peripheral face of the inner tube, the retaining member comprises a pair of end wall portions supported on the mounting recess and a flexible connecting wall portion integrally connecting the end wall portions so as to close the mounting recess, the detent projection being provided on the connecting wall portion, the resilient member urging the connecting wall portion toward the outer tube side is housed in the mounting recess, and the plurality of detent grooves are provided on the inner peripheral face of the outer tube.

According to a fifth aspect of the present invention, in addition to any one of the first to fourth aspects, a cover is mounted on opposite ends of the outer tube, the cover sealing the interior thereof.

According to a sixth aspect of the present invention, in addition to the fifth aspect, axial movement of the retaining member and the resilient member is restricted by the cover.

According to a seventh aspect of the present invention, in addition to the first or second aspect, a mounting recess opening toward an outer peripheral face of the inner tube is provided on an inner peripheral face of the outer tube, the retaining member is fitted into the mounting recess so that the retaining member can slide in the radial direction of the outer tube, the resilient member, which urges the retaining member toward the inner tube side, is housed in the mounting recess, and a plurality of detent grooves that the detent projection of the retaining member engages with and disengages from in response to relative rotation of the inner tube and the outer tube are provided on the outer peripheral face of the inner tube.

According to an eighth aspect of the present invention, in addition to the first or second aspect, a mounting recess opening toward an inner peripheral face of the outer tube is provided on an outer peripheral face of the inner tube, the retaining member is fitted into the mounting recess so that the retaining member can slide in the radial direction of the inner tube, the resilient member, which urges the retaining member toward the outer tube side, is housed in the mounting recess, and a plurality of detent grooves that the detent projection of the retaining member engages with and disengages from in response to relative rotation of the inner tube and the outer tube are provided on the inner peripheral face of the outer tube.

According to a ninth aspect of the present invention, in addition to the first, third, fourth, seventh or eighth aspect, the detent projection comprises a detent roller that is rotatably retained on the corresponding retaining member and can roll on the outer peripheral face of the inner tube or inner peripheral face of the outer tube that has the detent groove.

According to a tenth aspect of the present invention, in addition to the first, third, fourth, seventh or eighth aspect, the detent projection is formed integrally with the corresponding retaining member.

According to an eleventh aspect of the present invention, in addition to the third, fourth, seventh or eighth aspect, the resilient member is made of rubber and is packed into the mounting recess in a compressed state, and the surface of this resilient member is in resilient intimate contact with the resilient member.

### EFFECTS OF THE INVENTION

In accordance with the first aspect of the present invention, since the check force generation mechanism is formed from the plurality of retaining members that are mounted on one of the inner tube and the outer tube so as to be arranged in the peripheral direction thereof and that are capable of moving toward and away from the other one of the inner tube and the outer tube, and the plurality of resilient members individually urging these retaining members toward the other one, the detent projection projecting so as to abut against a peripheral face of the other one is provided on the retaining member, and the plurality of detent grooves that the detent projection engages with and disengages from in response to relative rotation of the inner tube and the outer tube are provided on the peripheral face of the other one, the plurality of retaining members individually receive an urging force directly from the plurality of resilient members, and it is thus possible to engage the detent projection with the detent groove and apply a check force to the door by virtue of the engagement force. Even if some of the resilient members lose the urging force for any reason, since the other normal resilient members continue to urge the corresponding retaining member, it is possible to prevent loss of the check function of the check force generation mechanism, thereby enhancing the reliability.

Furthermore, since the pressure-receiving area of the retaining member that receives pressure from the resilient member is set so as to be larger than the abutment area of the detent projection against the detent groove, the surface pressure between the retaining member and the resilient member can be reduced sufficiently, and not only it is possible to enhance the wear resistance thereof, but also the retaining member amplifies the pressure received from the resilient member and transmits it from the detent projection to the detent groove; this can strengthen effectively the engagement force between the detent projection and the detent groove and, consequently, the check tor on the door.

In accordance with the second aspect of the present invention, the inner tube, the outer tube, and the check force generation mechanism can be arranged by utilizing effectively a space between the pair of male arm portions disposed between the pair of female arm portions, and it is therefore possible to make the checker-equipped door hinge device compact.

In accordance with the third aspect of the present invention, since the mounting recess opening toward the outer peripheral face of the inner tube is provided on the inner peripheral face of the outer tube, the retaining member is formed from the pair of end wall portions supported on the mounting recess and the flexible connecting wall portion integrally connecting the end wall portions and closing the mounting recess, the detent projection being provided on the connecting wall portion, the resilient member urging the connecting wall portion toward the inner tube side is housed in the mounting recess, and the plurality of detent grooves are provided on the outer peripheral face of the inner tube, it is possible for the retaining member and the resilient member to be retained compactly on the outer tube, and it is possible to transmit an urging force from the resilient member to the detent projection and the detent groove by virtue of flexure of the connecting wall portion while eliminating a sliding part between the retaining member and the mounting recess, thereby preventing the occurrence of frictional noise. Moreover, since a relatively large capacity mounting recess can be formed in the outer tube, which has a larger diameter than that of the inner tube, the large volume resilient member can be housed therewithin, and the engagement force between the detent projection and the detent groove can easily be enhanced.

In accordance with the fourth aspect of the present invention, since the mounting recess opening toward the inner peripheral face of the outer tube is provided on the outer peripheral face of the inner tube, the retaining member is formed from the pair of end wall portions supported on the mounting recess and the flexible connecting wall portion integrally connecting the end wall portions and closing the mounting recess, the detent projection being provided on the connecting wall portion, the resilient member urging the connecting wall portion toward the outer tube side is housed in the mounting recess, and the plurality of detent grooves are provided on the inner peripheral face of the outer tube, it is possible for the retaining member and the resilient member to be retained compactly on the outer tube, and it is possible to transmit an urging force from the resilient member to the detent projection and the detent groove by virtue of flexure of the connecting wall portion while eliminating a sliding part between the retaining member and the mounting recess, thereby preventing the occurrence of frictional noise. Moreover, since the plurality of detent grooves are provided on the inner peripheral face of the outer tube, which has a larger diameter than that of the inner tube, the rotational radius of the detent groove becomes relatively long compared with a case in which the detent groove is provided on the outer peripheral face of the inner tube, and a large check torque can easily be applied to the door.

In accordance with the fifth aspect of the present invention, since opposite ends of the outer tube are equipped with a cover sealing the interior thereof, it is possible to prevent rainwater or dust particles from entering the interior of the outer tube and, consequently, the check force generation mechanism, thereby guaranteeing normal functioning of the check force generation mechanism over a long period of time.

In accordance with the sixth aspect of the present invention, the cover also functions as a stopper member for restraining axial movement of the retaining member and the resilient member, thereby contributing to a reduction in the number of components and, consequently, simplification of the structure.

In accordance with the seventh aspect of the present invention, since the mounting recess opening toward the outer peripheral face of the inner tube is provided on the inner peripheral face of the outer tube, the retaining member is fitted into the mounting recess so that it can slide in the radial direction of the outer tube, the resilient member urging this retaining member toward the inner tube side is housed within the mounting recess, and the plurality of detent grooves that the detent projection of the retaining member engages with and disengages from in response to relative rotation between the inner tube and the outer tube are provided on the outer peripheral face of the inner tube, it is possible for the retaining member and the resilient member to be retained on the outer tube compactly and, moreover, it is possible to efficiently transmit an urging force from the resilient member to the detent projection and the detent groove due to sliding of the retaining member within the mounting recess. Moreover, since a relatively large capacity mounting recess can be formed in the outer tube, which has a larger diameter than that of the inner tube, the large volume resilient member can be packed into the recess, and the engagement force between the detent projection and the detent groove can easily be enhanced.

In accordance with the eighth aspect of the present invention, since the mounting recess opening toward the inner peripheral face of the outer tube is provided on the outer peripheral face of the inner tube, the retaining member is fitted into the mounting recess so that it can slide in the radial direction of the inner tube, the resilient member urging this retaining member toward the outer tube side is housed within the mounting recess, and the plurality of detent grooves that the detent projection of the retaining member engages with and disengages from in response to relative rotation between the inner tube and the outer tube are provided on the inner peripheral face of the outer tube, it is possible for the retaining member and the resilient member to be retained on the inner tube compactly and, moreover, it is possible to efficiently transmit an urging force from the resilient member to the detent projection and the detent groove due to sliding of the retaining member within the mounting recess. Moreover, since the plurality of detent grooves are provided on the inner peripheral face of the outer tube, which has a larger diameter than that of the inner tube, the rotational radius of the detent groove becomes relatively long compared with a case in which the detent groove is provided on the outer peripheral face of the inner tube, and a large check torque can easily be applied to the door.

In accordance with the ninth aspect of the present invention, since the detent projection is formed from the detent roller that is rotatably retained by the corresponding retaining member and is capable of rolling on the outer peripheral face of the inner tube or inner peripheral face of the outer tube having the detent groove, when the inner tube and the outer tube pivot relative to each other the detent roller rolls on the outer peripheral face of the inner tube or inner peripheral face of the outer tube that has the detent groove, and pivoting of the door in an area other than the check position can be carried out smoothly.

In accordance with the tenth aspect of the present invention, by molding the detent projection integrally with the retaining member, the structure can be simplified due to a reduction in the number of components, thus reducing the cost.

In accordance with the eleventh aspect of the present invention, the space within the mounting recess can be utilized effectively for packing a rubber resilient member, and the check force generation mechanism can be made compact. In particular, when this rubber resilient member is packed into the mounting recess, into which the retaining member is slidably fitted, since the compression ratio of the resilient member accompanying displacement of the retaining member can be enhanced sufficiently, the engagement force between the detent projection and the detent groove can be increased effectively.

### BRIEF DESCRIPTION OF DRAWINGS

FIG. 1 is a plan view of an essential part of an automobile that includes a checker-equipped door hinge device related to a first embodiment of the present invention. (first embodiment)

FIG. 2 is an exploded perspective view of the checker-equipped door hinge device. (first embodiment)

FIG. 3 is a plan view showing the checker-equipped door hinge device in a state in which the door is closed. (first embodiment)

FIG. 4 is a view from arrow 4 in FIG. 3. (first embodiment)

FIG. 5 is a sectional view along line 5-5 in FIG. 4. (first embodiment)

FIG. 6 is a view, corresponding to FIG. 5, showing the checker-equipped door hinge device in a state in which the door is fully open. (first embodiment)

FIG. 7 is a sectional view along line 7-7 in FIG. 5. (first embodiment)

FIG. 8 is a sectional view along line 8-8 in FIG. 5. (first embodiment)

FIG. 9 is a view, corresponding to FIG. 5, showing a second embodiment of the present invention. (second embodiment)

FIG. 10 is a view, corresponding to FIG. 5, showing a third embodiment of the present invention. (third embodiment)

FIG. 11 is a view, corresponding to FIG. 5, showing a fourth embodiment of the present invention. (fourth embodiment)

FIG. 12 is a view, corresponding to FIG. 10, showing a fifth embodiment of the present invention. (fifth embodiment)

### EXPLANATION OF REFERENCE NUMERALS AND SYMBOLS

B Body
D Door
H Door hinge
1 First bracket (female bracket)
2 Second bracket (male bracket)
5 Hinge pin
6 Inner tube
7 Outer tube
10 Cover
16 Bearing bush
20 Check force generation mechanism
21 Mounting recess
22 Retaining member
22a End wall portion
22b Connecting wall portion
26 Detent projection (detent roller)
27 Detent groove

### BEST MODE FOR CARRYING OUT THE INVENTION

Modes for carrying out the present invention are explained below by reference to preferred embodiments of the present invention shown in the attached drawings.

### Embodiment 1

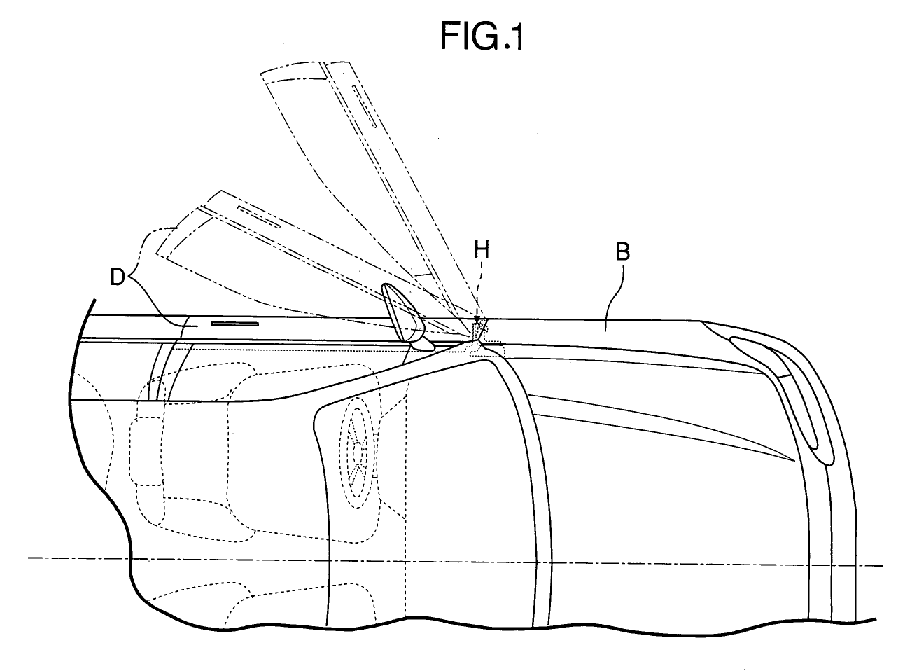

A first embodiment of the present invention is now explained. In FIG. 1, a door D is pivotably mounted on a body B of an automobile via a door hinge H so as to open and close an entrance thereof.

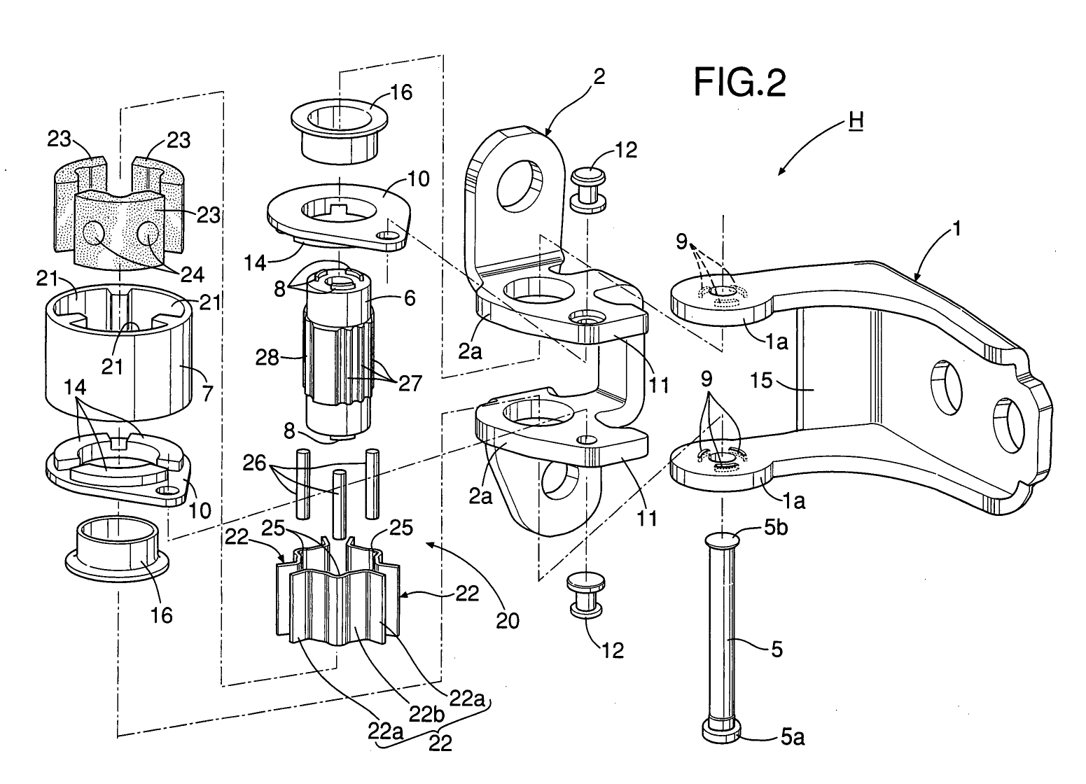

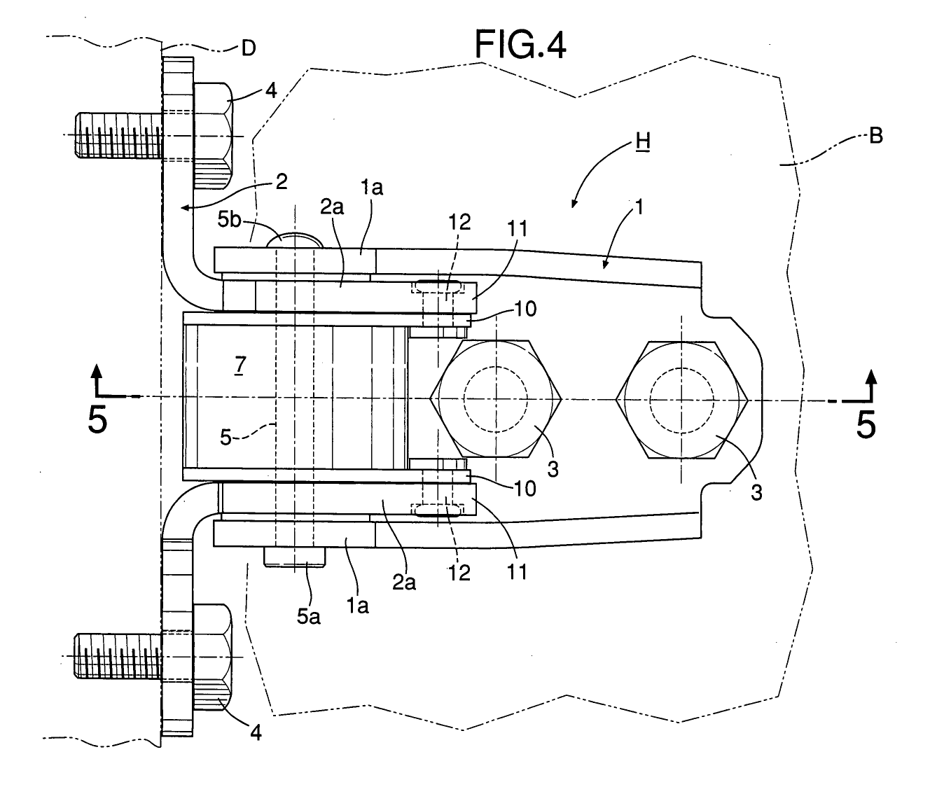

As shown in FIG. 2 to FIG. 5, each door hinge H is formed from a female bracket 1 secured to the body B via a plurality of bolts 3, a male bracket 2 secured to the door D via a plurality of bolts 4, and a hinge pin 5 disposed in the vertical direction so as to relatively pivotably connect these two brackets 1 and 2.

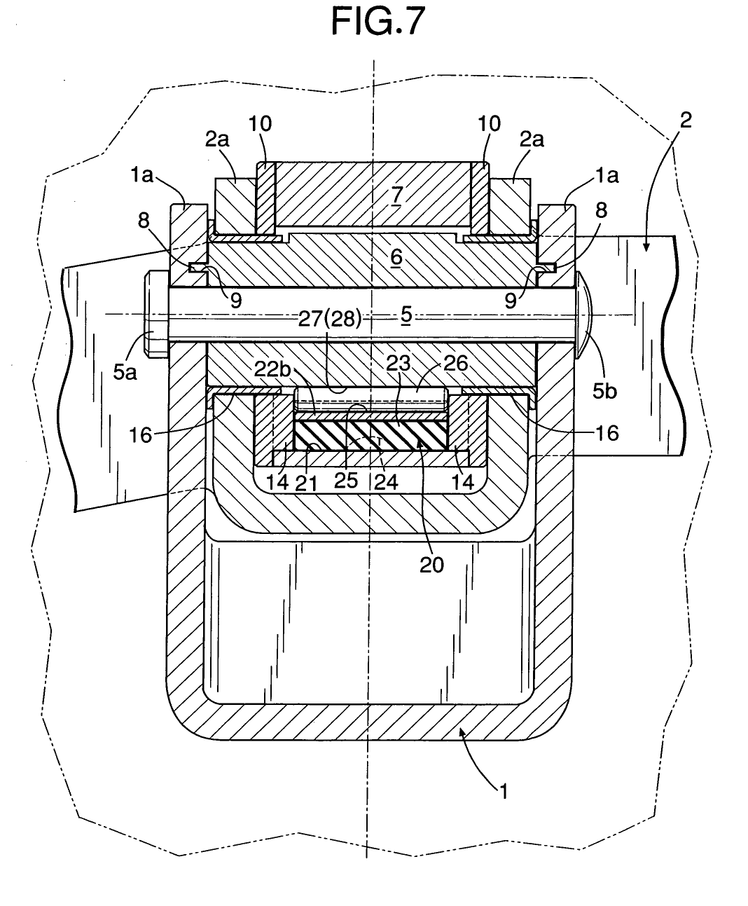

The female bracket 1 has a pair of upper and lower female arm portions 1a, a pair of upper and lower male arm portions 2a and 2a of the male bracket 2 are disposed inside the female arm portions 1a so as to be respectively adjacent thereto, and the hinge pin 5 is disposed so as to extend vertically therethrough. The hinge pin 5 is secured to the female arm portion 1a via an expanded head portion 5a at one end and an upset portion 5b at the other end. An inner tube 6 is fitted into the outer periphery of the hinge pin 5, the inner tube 6 extending through the female arm portion 1a, and opposite end parts of the inner tube 6 are integrally joined to the female arm portion 1a by engagement of a plurality of projections 8 and recesses 9 (see FIG. 7) respectively provided on opposing faces thereof. The opposite end parts of the inner tube 6 relatively rotatably support the pair of male arm portions 2a and 2a via bearing bushes 16 (also see FIG. 7).

Disposed on the outer periphery of the inner tube 6 is an outer tube 7, which can rotate relative thereto, and disposed at opposite ends of the outer tube 7 are a pair of upper and lower covers 10, which are rotatably supported on the outer periphery of the bearing bush 16 while sealing the interior of the outer tube 7.

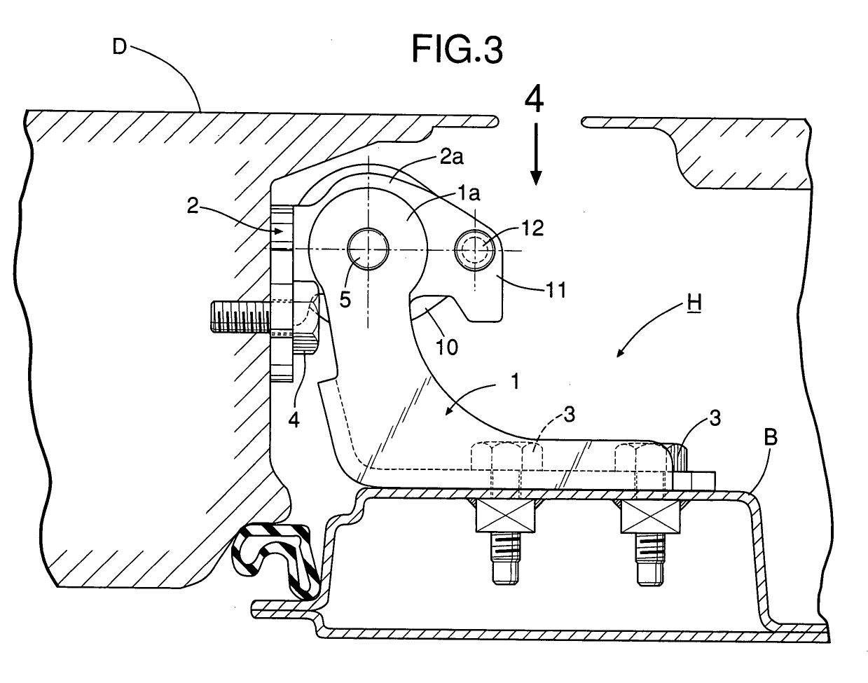

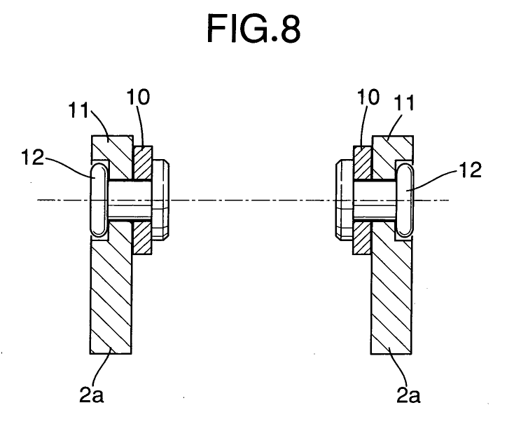

As shown in FIG. 3 and FIG. 8, the male arm portions 2a and 2a integrally have a radially projecting ear part 11, and the covers 10 are secured to the ear parts 11 via a rivet 12. The covers 10 include projections 14 and 14 on inside faces thereof, the projections 14 and 14 being fitted into an open end part, in the axial direction, of a mounting recess 21 of the outer tube 7, which is described later. The outer tube 7 is thus joined to the male arm portions 2a and 2a via the cover 10.

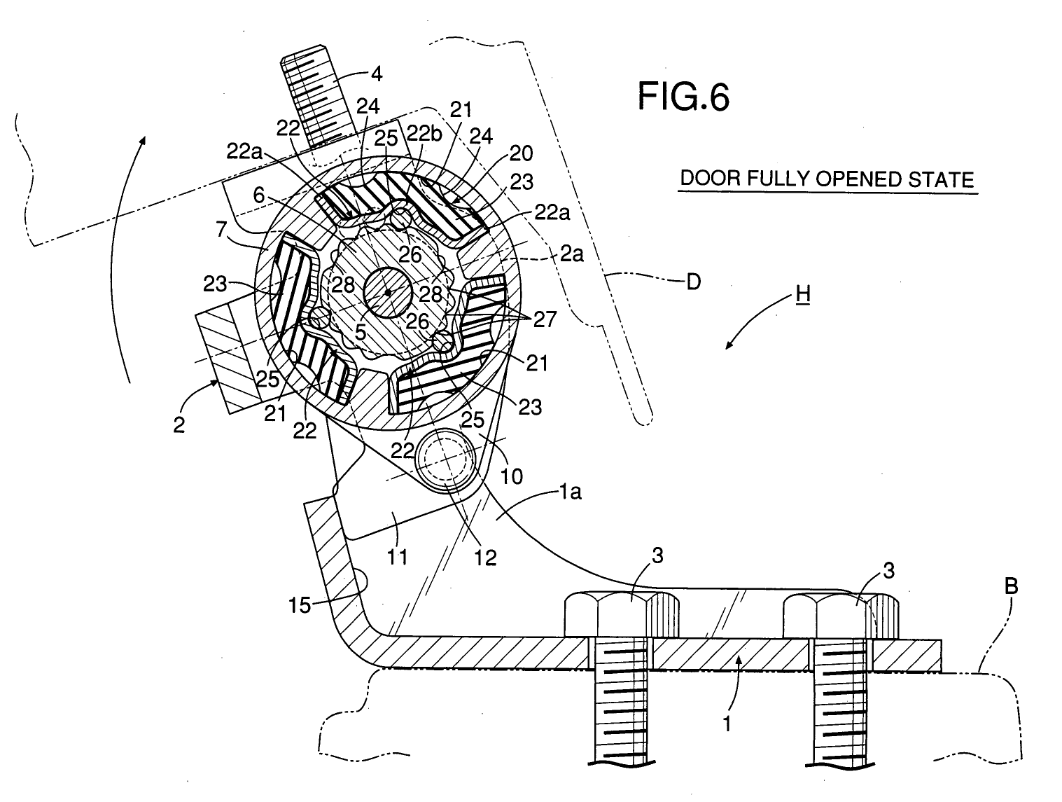

As shown in FIG. 6, formed integrally with the female bracket 1 is a stopper wall 15, a fully open position of the door D being restricted by the ear parts 11 of the male arm portions 2a and 2a abutting against the stopper wall 15.

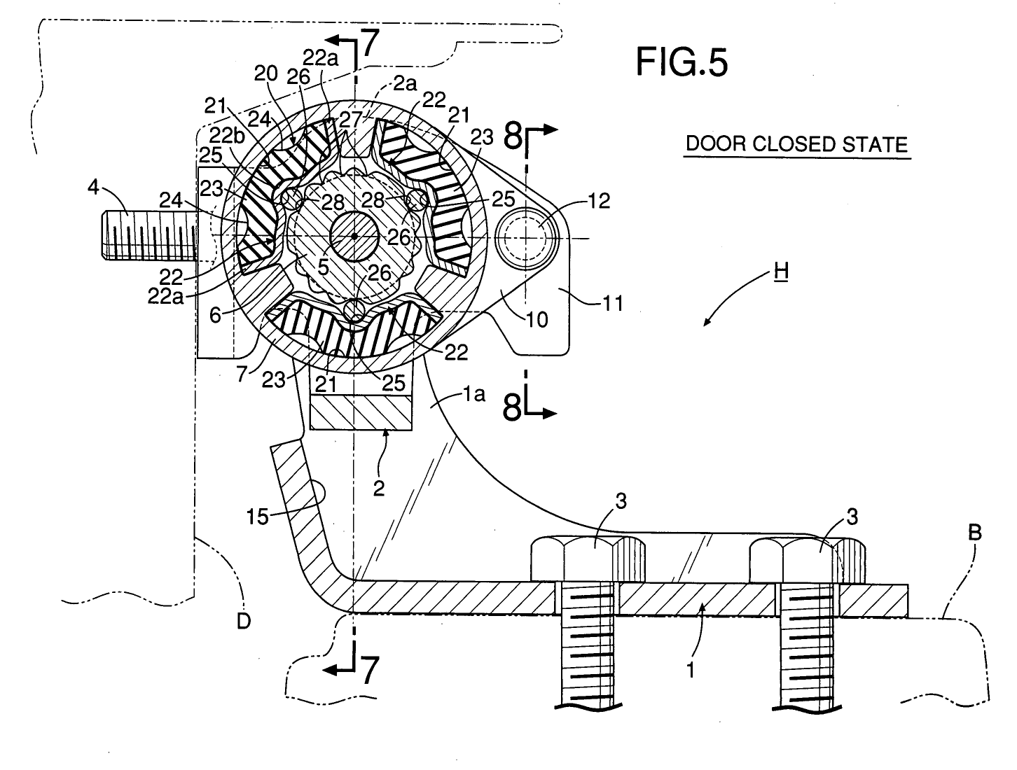

In FIG. 2, and FIG. 5 to FIG. 7, a check force generation mechanism 20 that generates a check force on the door D at an intermediate degree of opening position and the fully open position of the door D is provided between the inner tube 6 and the outer tube 7; an explanation thereof is given below.

As clearly shown in FIG. 5, a plurality (three in the illustrated example) of mounting recesses 21 opening toward the inner tube 6 are formed at equal intervals in the peripheral direction on an inner peripheral face of the outer tube 7. Each mounting recess 21 has a fan-shaped cross-sectional shape in which the width in the peripheral direction increases in the radially outward direction of the outer tube 7, and opens on opposite end faces of the outer tube 7. A retaining member 22 is fitted into each mounting recess 21. This retaining member 22 is formed from one sheet of plate spring material, includes a pair of end wall portions 22a superimposed on inner walls of the mounting recess 21, which face each other in the peripheral direction of the outer tube 7, and a flexible connecting wall portion 22b integrally connecting these end wall portions 22a, and a rubber resilient member 23 is packed into the mounting recess 21 in a compressed state, the resilient member 23 being in intimate contact with the surface of the flexible connecting wall portion 22b and resiliently urging the connecting wall portion 22b toward the inner tube 6. This resilient member 23 is provided with a cutout 24 for adjusting the compressive modulus of elasticity thereof.

Formed on the connecting wall portion 22b of each retaining member 22 is a semi-cylindrical retaining groove 25 opening toward the inner tube 6 and extending in the axial direction of the outer tube 7, and substantially half of the periphery of a detent roller 26 capable of rolling on an outer peripheral face of the inner tube 6 rotatably engages with and is retained by this retaining groove 25. On the other hand, the outer peripheral face of the inner tube 6 is provided with a plurality of V-shaped cross-section detent grooves 27 extending in the axial direction of the inner tube 6, each detent roller 26 engaging with and disengaging from the detent groove 27 in response to relative rotation between the inner tube 6 and the outer tube 7.

Each detent roller 26 generates a check force on the door D by engaging with the corresponding detent groove 27 by virtue of the resilient force of the corresponding resilient member 23; in the case of the illustrated example, a group of three of the detent grooves 27 are provided so as to correspond to each detent roller 26 so as to generate a check force at two intermediate positions and the fully open position of the door D, and a roller release groove 28 having a wider width than that of the detent groove is provided so as to be adjacent to one side of the detent groove 27, the roller release groove 28 freeing the detent roller 26 at a closed position of the door D.

Axial movement of the retaining member 22, the resilient member 23, and the detent roller 26 is restrained by the cover 10, which closes opposite ends of the outer tube 7.

In the arrangement above, a pressure-receiving area of the connecting wall portion 22b that receives pressure from the resilient member 23 is set so as to be sufficiently larger than an abutment area of the detent roller 26 against the detent groove 27.

The operation of this embodiment is now explained.

When a user pivots the door D between the fully closed position and the fully open position, since the male bracket 2 joined to the door D pivots between the closed position (the state in FIG. 3 and FIG. 5) and the fully open position (the state in FIG. 6), the outer tube 7 connected to the male bracket 2 rotates relative to the inner tube 6, which is connected to the female bracket 1. When this outer tube 7 rotates, since the retaining member 22 and the resilient member 23 supported on the mounting recess 21 rotate at the same time, the detent roller 26 retained by the retaining groove 25 of the retaining member 22 moves while rolling on the outer peripheral face of the inner tube 6.

In this process, when the door D comes to a predetermined intermediate degree of opening position or the fully open position, the detent roller 26 attains a position at which it can engage with the predetermined detent groove 27 corresponding to these positions. The connecting wall portion 22b of the retaining member 22 retaining the detent roller 26 flexes toward the inner tube 6 side by virtue of compressive repulsion of the resilient member 23, thus pushing the detent roller 26 into the detent groove 27.

Furthermore, when the door D receives a pivoting force as an external force and the detent roller 26 starts to climb up an inclined face of the detent groove 27 so as to escape from the detent groove 27 of the inner tube 6, since the connecting wall portion 22b of each retaining member 22 receives a pressing force from the detent roller 26 and flexes radially outward within the mounting recess 21 to thus compress the resilient member 23, a large compressive repulsion is generated in the resilient member 23. Therefore, due to such a large compressive repulsion of the resilient member 23 being generated, it is possible to generate a large engagement force between the detent roller 26 and the detent groove 27 and, consequently, a large check torque on the door D. Moreover, since the pressure-receiving area of the connecting wall portion 22b for the resilient member 23 is set so as to be sufficiently larger than the abutment area of the detent roller 26 against the detent groove 27, the connecting wall portion 22b can amplify the pressure received from the resilient member 23 and transmit it to the detent roller 26, the engagement force of the detent roller 26 and the detent groove 27 can thereby be increased, and free movement of the door D can be prevented.

Furthermore, since the plurality of retaining members 22 and resilient members 23 arranged in the peripheral direction of the outer tube 7 operate individually, even if some of the resilient members 23 lose the resilient force for any reason, another normal resilient member 23 continues to press the corresponding retaining member 22, and loss of the check function of the check force generation mechanism can be prevented, thus enhancing the reliability.

Moreover, since the pressure-receiving area of the retaining member 22 that receives pressure from the resilient member 23 is set so as to be larger than the abutment area of the detent roller 26 against the detent groove 27, the surface pressure between the retaining member 22 and the resilient member 23 can be reduced sufficiently, and not only is it possible to enhance the wear resistance thereof, but it is also possible for the retaining member 22 to amplify pressure received from the resilient member 23 and transmit it to the detent roller 26 and the detent groove 27, thereby increasing effectively the engagement force of the detent roller 26 and the detent groove 27 and, consequently, the check torque on the door D.

Furthermore, since the female bracket 1 is provided with the pair of female arm portions la that support opposite end parts of the hinge pin 5 and are joined to the inner tube 6 disposed on the outer periphery of the hinge pin 5, the male bracket 2 is provided with the pair of male arm portions 2a and 2a disposed so as to be adjacent to the inside of the female arm portions 1a and relatively rotatably supported on the outer periphery of opposite ends of the inner tube 6 via the bearing bushes 16, and the outer tube 7 disposed between the two male arm portions 2a and 2a is joined thereto, it is possible to arrange the inner tube 6, the outer tube 7, and the check force generation mechanism 20 by effective utilization of space between the pair of male arm portions 2a and 2a disposed between the pair of female arm portions 1a, thereby making the checker-equipped door hinge device compact.

Moreover, since the plurality of mounting recesses 21 opening toward the outer peripheral face of the inner tube 6 are provided on the inner peripheral face of the outer tube 7, the retaining member 22 is formed from the pair of end wall portions 22a superimposed on the inner walls of the mounting recess 21 that face each other in the peripheral direction of the outer tube 7 and the flexible connecting wall portion 22b integrally connecting these end wall portions 22a, the retaining groove 25 retaining the detent roller 26 being formed in the connecting wall portion 22b, and the resilient member 23 urging the connecting wall portion 22b toward the inner tube 6 side is made of rubber and packed into the mounting recess 21, it is possible to retain the retaining member 22 and the resilient member 23 compactly on the outer tube 7, and the resilient force can be transmitted from the resilient member 23 to the detent roller 26 by flexure of the connecting wall portion 22b while eliminating a sliding part between the retaining member 22 and the mounting recess 21, thereby preventing the occurrence of frictional noise. Moreover, since a relatively large capacity mounting recess 21 is formed in the outer tube 7, which has a larger diameter than that of the inner tube 6, the large volume rubber resilient member 23 can be packed into the mounting recess 21, thereby enabling setting of the resilient force against the detent roller 26 to be carried out easily.

Moreover, since the pair of covers 10 are mounted on opposite ends of the outer tube 7, the covers 10 sealing the interior thereof and restraining axial movement of the detent roller 26, the retaining member 22, and the resilient member 23, it is possible to prevent rain water or dust particles from entering the interior of the outer tube 7 and, consequently, the check force generation mechanism 20, thereby guaranteeing normal functioning of the check force generation mechanism 20 over a long period of time. Moreover, the cover 10 also functions as a stopper member for restraining axial movement of the detent roller 26, the retaining member 22, and the resilient member 23, thereby contributing to a reduction in the number of components and, consequently, simplification of the structure.

Furthermore, since the rubber resilient member 23 is packed into the mounting recess 21 in a compressed state, and the surface of the resilient member 23 is in resilient intimate contact with a resilient member, it is possible to utilize the space within the mounting recess 21 effectively for packing the rubber resilient member 23, thereby making the check force generation mechanism 20 compact.

### Embodiment 2

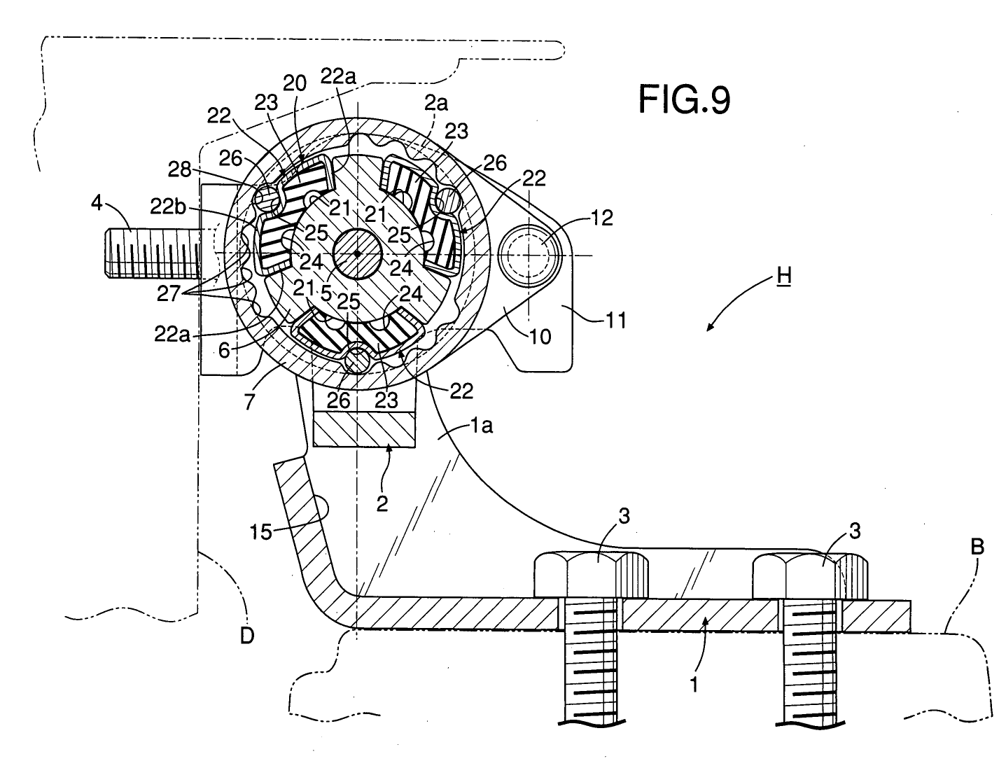

A second embodiment of the present invention shown in FIG. 9 is now explained.

This second embodiment is different from the preceding embodiment in that, with regard to a check force generation mechanism 20, a retaining member 22 and a resilient member 23 are mounted on an inner tube 6, and a detent groove 27 is provided on an inner peripheral face of an outer tube 7. That is, a plurality of mounting recesses 21 opening toward the inner peripheral face of the outer tube 7 are provided on an inner peripheral face of the inner tube 6, the retaining member 22 is formed from a pair of end wall portions 22a superimposed on inner walls of the mounting recess 21, which face each other in the peripheral direction of the inner tube 6, and a flexible connecting wall portion 22b providing an integral connection between the end wall portions 22a, a retaining groove 25 for retaining a detent roller 26 is formed on the connecting wall portion 22b, the resilient member 23, which is made of rubber and urges the connecting wall portion 22b toward the outer tube 7 side, is packed into each of the mounting recesses 21, and a plurality of detent grooves 27 engaging with and disengaging from the detent roller 26 are provided on the inner peripheral face of the outer tube 7. The arrangement is otherwise the same as the preceding embodiment; in FIG. 9, portions corresponding to those in the preceding embodiment are denoted by the same reference numerals and symbols, and duplication of the explanation is omitted.

In accordance with this second embodiment, in addition to the same operational effects as those of the preceding embodiment being attained, since the plurality of detent grooves 27 are provided on the inner peripheral face of the outer tube 7, which has a larger diameter than that of the inner tube 6, the rotational diameter of the detent groove 27 around a hinge pin 5 becomes relatively long compared with a case in which a detent groove 27 is provided on an outer peripheral face of an inner tube 6, thereby enabling a large check torque to be easily applied to a door D.

### Embodiment 3

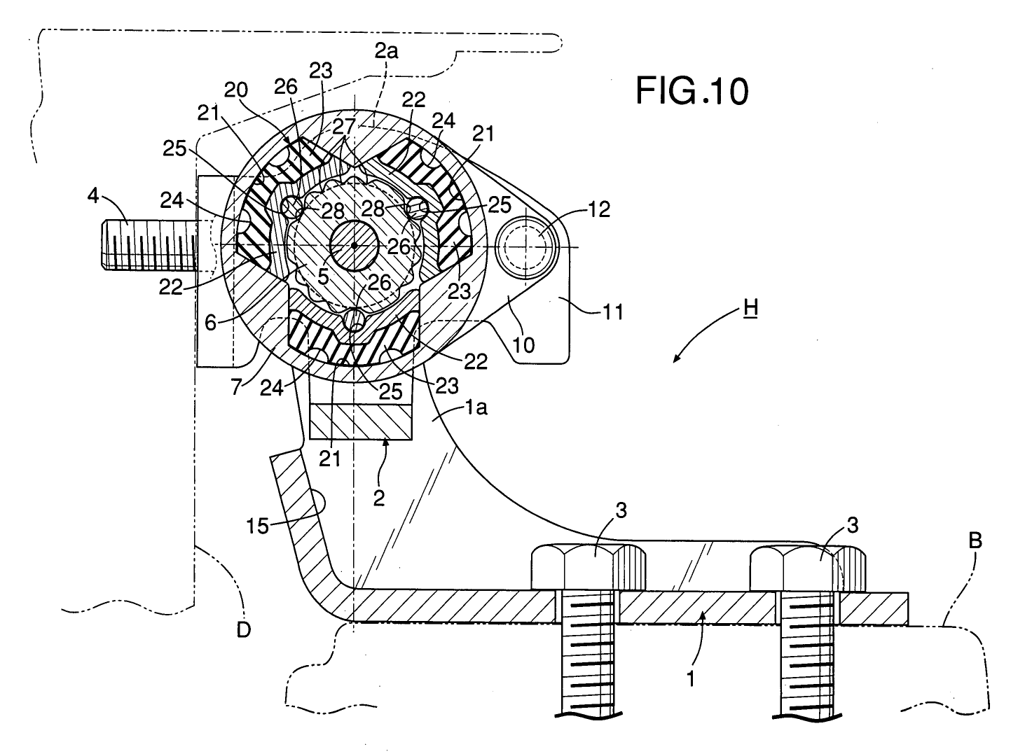

A third embodiment of the present invention shown in FIG. 10 is now explained.

In this third embodiment, with regard to a check force generation mechanism 20, a plurality of mounting recesses 21 formed on an inner peripheral face of an outer tube 7 so as to be arranged in the peripheral direction are formed so that inside faces thereof, which face each other in the peripheral direction of the outer tube 7, are parallel. A plurality of high rigidity retaining members 22 are fitted into each of these mounting recesses 21 so that they can slide in the radial direction of the outer tube 7, and resilient members 23 resiliently urging these retaining members 22 toward the inner tube 6 are packed into the mounting recesses 21.

The arrangement is otherwise the same as the first embodiment; in FIG. 10, portions corresponding to those of the first embodiment are denoted by the same reference numerals and symbols, and duplication of the explanation is omitted.

In accordance with this third embodiment, when, due to relative pivoting between the outer tube 7 and the inner tube 6 accompanying opening and closing of a door D, a detent roller 26 retained by each retaining member 22 starts to climb up an inclined face of a detent groove 27 so as to escape from the detent groove 27 of the inner tube 6, each retaining member 22 receives a pressing force from the detent roller 26 and slides radially outward within the mounting recess 21, thus equally compressing each part of the resilient member 23 via the whole of a pressure-receiving face of each retaining member 22; the compression ratio is therefore higher than in the case of the first embodiment in which the resilient member 23 is compressed while making the connecting wall portion 22b flex, and a large compressive repulsion is thereby generated in the resilient member 23. Therefore, by setting the pressure-receiving area of the retaining member 22 that receives pressure from the resilient member 23 so as to be larger than the abutment area of the detent roller 26 against the detent groove 27, the retaining member 22 can amplify effectively pressure received from the resilient member 23 and transmit it to the detent roller 26 and the detent groove 27, thereby increasing the engagement force of the detent roller 26 and the detent groove 27 and, consequently, the check tor on the door D yet more effectively.

### Embodiment 4

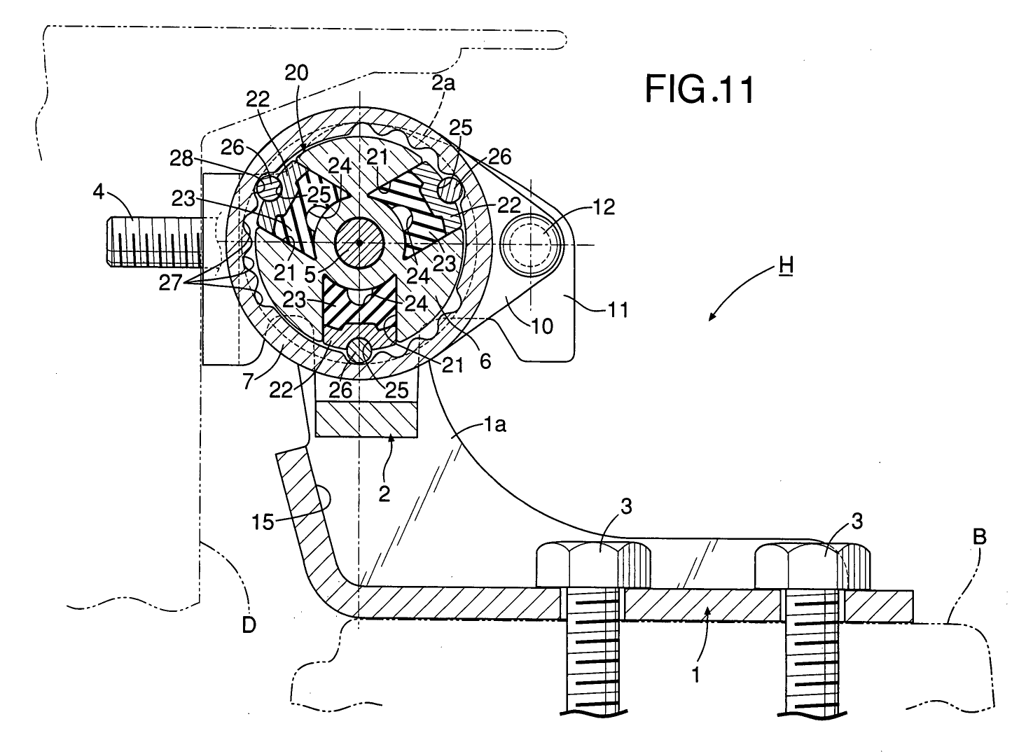

A fourth embodiment of the present invention shown in FIG. 11 is now explained.

This fourth embodiment is different from the third embodiment in terms of a retaining member 22 and a resilient member 23 being mounted on an inner tube 6, and a detent groove 27 being provided on an inner peripheral face of an outer tube 7. That is, a plurality of mounting recesses 21 opening toward the inner peripheral face of the outer tube 7 are provided on an inner peripheral face of an inner tube 6, a high rigidity retaining member 22 is radially slidably fitted into each mounting recess 21, a retaining groove 25 for retaining a detent roller 26 is formed on the retaining member 22, the resilient member 23, which is made of rubber and urges the retaining member 22 toward the outer tube 7 side, is packed into each of the mounting recesses 21, and a plurality of detent grooves 27 that the detent roller 26 engages with and disengages from are provided on the inner peripheral face of the outer tube 7. The arrangement is otherwise the same as the third embodiment; in FIG. 9, portions corresponding to those of the third embodiment are denoted by the same reference numerals and symbols, and duplication of the explanation is omitted.

In accordance with this fourth embodiment, in addition to the same operational effects as those of the third embodiment being attained, since the plurality of detent grooves 27 are provided on the inner peripheral face of the outer tube 7, which has a larger diameter than that of the inner tube 6, the rotational diameter of the detent groove 27 around a hinge pin 5 becomes relatively long compared with a case in which a detent groove 27 is provided on an outer peripheral face of an inner tube 6, thereby enabling a large check torque to be easily applied to a door D.

### Embodiment 5

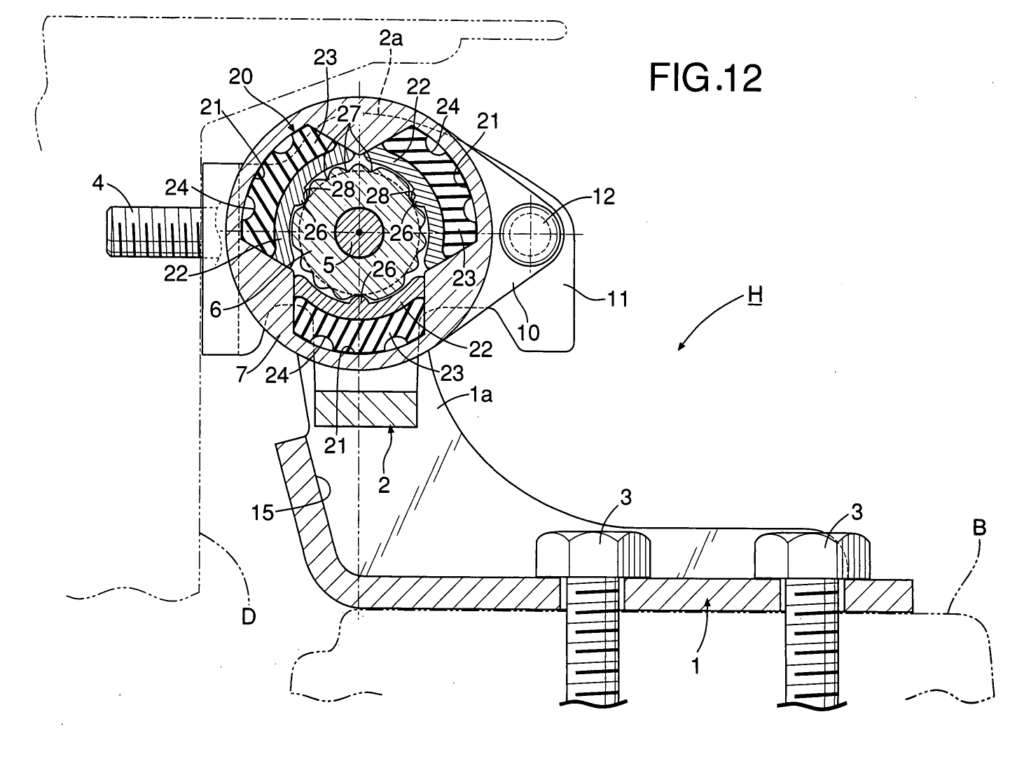

Finally, a fifth embodiment of the present invention shown in FIG. 12 is explained.

This fifth embodiment illustrates that instead of the detent roller 26 as in the first to fourth embodiments, a retaining member 22 can be formed integrally with a semi-cylindrical detent projection 26 extending in the axial direction of an outer tube 7 and an inner tube 6, and as a representative example thereof a modification in which the retaining member 22 and detent projection 26 of the third embodiment in FIG. 9 are modified is shown in FIG. 12. The arrangement is otherwise the same as the third embodiment; in FIG. 12, portions corresponding to those of the third embodiment are denoted by the same reference numerals and symbols, and duplication of the explanation is omitted.

In accordance with this fifth embodiment, by forming the detent projection 26 integrally with the retaining member 22, the structure can be simplified due to a reduction in the number of components, thereby reducing the cost.

The present invention is not limited to the above-mentioned embodiments, and may be modified in a variety of ways as long as the modifications do not depart from the spirit and scope thereof. For example, the female bracket 1 may be secured to the door D, and the male bracket 2 may be secured to the body B. Furthermore, the hinge pin 5 and the inner tube 6 may be formed as a unit. Moreover, the checker-equipped door hinge device may be applied to a hinge device supporting a door for opening and closing a tailgate of a wagon type vehicle. Furthermore, as the resilient member 23 a metal coil spring, disc spring, plate spring, etc. may be used.

1. A vehicular checker-equipped door hinge device comprising a first bracket secured to one of a body and a door, a second bracket secured to the other one thereof, a hinge pin relatively pivotably connecting these two brackets, an inner tube integrally joined to the first bracket and disposed coaxially with the hinge pin, an outer tube integrally joined to the second bracket and disposed so as to relatively rotatably surround the inner tube, and a check force generation mechanism provided between the inner tube and the outer tube and generating a check force on the door at a predetermined degree of opening position of the door,
characterized in that the check force generation mechanism comprises a plurality of retaining members that are mounted on one of the inner tube and the outer tube so as to be arranged in the peripheral direction and that are capable of moving toward and away from the other one of the inner tube and the outer tube, and a plurality of resilient members individually urging these retaining members toward said other one, each of the retaining members is provided with a detent projection projecting so as to abut against a peripheral face of said other one, a plurality of detent grooves that the detent projection engages with and disengages from in response to relative rotation of the inner tube and the outer tube are provided on a peripheral face of said other one, and a pressure-receiving area of the retaining member that receives pressure from the resilient member is set so as to be larger than an abutment area of the detent projection against the detent groove.

2. The vehicular checker-equipped door hinge device according to claim 1,
wherein the first bracket is provided with a pair of female arm portions that support opposite end parts of the hinge pin and are joined to the inner tube, the inner tube being disposed on the outer periphery of the hinge pin, the second bracket is provided with a pair of male arm portions that are disposed so as to be adjacent to the inside of the female arm portion and are relatively rotatably supported on the outer periphery of opposite end parts of the inner tube via bearing bushes, and the outer tube is joined to the two male arm portions, the outer tube being disposed therebetween.

3. The vehicular checker-equipped door hinge device according to claim 1 or 2,
wherein a mounting recess opening toward an outer peripheral face of the inner tube is provided on an inner peripheral face of the outer tube, the retaining member comprises a pair of end wall portions supported on the mounting recess and a flexible connecting wall portion integrally connecting the end wall portions so as to close the mounting recess, the detent projection being provided on the connecting wall portion, the resilient member urging the connecting wall portion toward the inner tube side is housed in the mounting recess, and the plurality of detent grooves are provided on an outer peripheral face of the inner tube.

4. The vehicular checker-equipped door hinge device according to claim 1 or 2,
wherein a mounting recess opening toward an inner peripheral face of the outer tube is provided on an outer peripheral face of the inner tube, the retaining member comprises a pair of end wall portions supported on the mounting recess and a flexible connecting wall portion integrally connecting the end wall portions so as to close the mounting recess, the detent projection being provided on the connecting wall portion, the resilient member urging the connecting wall portion toward the outer tube side is housed in the mounting recess, and the plurality of detent grooves are provided on the inner peripheral face of the outer tube.

5. The vehicular checker-equipped door hinge device according to claim 1 or claim 2,
wherein a cover is mounted on opposite ends of the outer tube, the cover sealing the interior thereof.

6. The vehicular checker-equipped door hinge device according to claim 5,
wherein axial movement of the retaining member and the resilient member is restricted by the cover.

7. The vehicular checker-equipped door hinge device according to claim 1 or 2,
wherein a mounting recess opening toward an outer peripheral face of the inner tube is provided on an inner peripheral face of the outer tube, the retaining member is fitted into the mounting recess so that the retaining member can slide in the radial direction of the outer tube, the resilient member, which urges the retaining member toward the inner tube side, is housed in the mounting recess, and a plurality of detent grooves that the detent projection of the retaining member engages with and disengages from in response to relative rotation of the inner tube and the outer tube are provided on the outer peripheral face of the inner tube.

8. The vehicular checker-equipped door hinge device according to claim 1 or 2,
wherein a mounting recess opening toward an inner peripheral face of the outer tube is provided on an outer peripheral face of the inner tube, the retaining member is fitted into the mounting recess so that the retaining member can slide in the radial direction of the inner tube, the resilient member, which urges the retaining member toward the outer tube side, is housed in the mounting recess, and a plurality of detent grooves that the detent projection of the retaining member engages with and disengages from in response to relative rotation of the inner tube and the outer tube are provided on the inner peripheral face of the outer tube.

9. The vehicular checker-equipped door hinge device according to claim 1,
wherein the detent projection comprises a detent roller that is rotatably retained on the corresponding retaining member and can roll on the outer peripheral face of the inner tube or inner peripheral face of the outer tube that has the detent groove.

10. The vehicular checker-equipped door hinge device according to claim 1,
wherein the detent projection is formed integrally with the corresponding retaining member.

11. The vehicular checker-equipped door hinge device according to claim 3,
wherein the resilient member is made of rubber and is packed into the mounting recess in a compressed state, and the surface of this resilient member is in resilient intimate contact with the resilient member.
